(19) United States
(12) Patent Application Publication
(10) Pub. No.: US 2013/0291907 A1
(43) Pub. Date: Nov. 7, 2013

(54) Spray Head Positioning Device

(71) Applicants: Jim David Brozik, Garner, IA (US); Matthew Koenen Koehler, Meservey, IA (US); Matthew Wendell Schroeder, Ventura, IA (US)

(72) Inventors: Jim David Brozik, Garner, IA (US); Matthew Koenen Koehler, Meservey, IA (US); Matthew Wendell Schroeder, Ventura, IA (US)

(21) Appl. No.: 13/465,510

(22) Filed: May 7, 2012

(51) Int. Cl. B08B 9/08

(52) U.S. Cl. 134/167 R

(57) ABSTRACT

Provided is a spray head positioning device that includes a wash head mounting structure, a telescoping structure attached to the wash head mounting structure, a guide, a track, a first arm, a second arm, a first actuator, a second actuator, and a third actuator. The telescoping structure may include a first sliding member telescopingly engaged with a second sliding member. The first arm and the second arm are configured to rotate while an end of the second sliding member moves along the track.

### BACKGROUND

1. Field

Example embodiments relate to a spray head positioning device and, in particular, a spray head positioning device usable with a mobile bin washing apparatus.

2. Description of the Related Art

Trash collection services typically use trucks to transport trash from residential and commercial properties to a landfill. The trucks are typically fitted with lifting devices that engage trash bins containing the trash. In general, the lifting devices grab and rotate the trash bins to empty the contents therein into the truck. These services, however, typically do not clean inside surfaces of the trash bins. Thus, any trash adhered to the inside surfaces of the trash bins may remain attached to the trash bin after the contents are emptied. The adhered trash may be comprised of organic matter which may decompose providing an unpleasant odor for those around the trash bin.

FIGS. 1A-1C illustrate an example of a bin cleaning apparatus 10 according to the conventional art. As shown in FIGS. 1A-1C, the conventional bin cleaning apparatus 10 includes a truck 20 and a truck bed 30 upon which a washing bin 40 is mounted. In the conventional art, the bin cleaning apparatus 10 includes a lifting device 50 which is configured to grab and rotate a trash bin 60. The conventional bin cleaning apparatus 10 also includes a spray nozzle 80 mounted on a hydraulically operated telescoping boom 70. The boom 70 is swivelly mounted at 75. The spray nozzle 80 is configured to spray water at a relatively high pressure. In this device, the spray nozzle 80 is manually swung up and down and side to side and hydraulically telescoped outwardly and retracted inwardly by suitable hydraulic controls on the swivel 75 so that an operator may direct water to an interior of the trash bin 60.

FIG. 1B illustrates an operation of the conventional bin cleaning apparatus 10 wherein the trash bin 60 is grabbed, lifted, and rotated by the lifting device 50. FIG. 1C shows the conventional bin cleaning apparatus 10 with the telescoping boom 70 extended so that the spray nozzle 80 is inserted into the trash bin 60 for cleaning. In the conventional art, the telescoping boom 70 takes up considerable space, is difficult to operate, and is prone to operator error since the telescoping boom 70 is manually swung up and down. Thus, a more compact robust apparatus is desired.

### SUMMARY

Example embodiments relate to a spray head positioning device and, in particular, a spray head positioning device usable with a mobile bin washing apparatus.

In accordance with example embodiments, a spray head positioning device may include a wash head mounting structure, a sliding structure supporting the wash head mounting structure, and a track configured to engage the sliding structure, wherein sliding structure includes an end configured to traverse along the track.

In accordance with example embodiments, a spray head positioning device may include a wash head mounting structure, a telescoping structure attached to the wash head mounting structure, a guide, a track, a first arm, a second arm, a first actuator, a second actuator, and a third actuator. In example embodiments, the telescoping structure may include a first sliding member telescopingly engaged with a second sliding member. In example embodiments, the guide may be attached to an end of the second sliding member and the guide may comprise a sleeve, a first rolling member, and a second rolling member. In example embodiments, the track may be comprised of a first track member and a second track member, wherein the first track member may support and restrain the first rolling member and the second track member may support and restrain the second rolling member. In example embodiments, the first arm may be connected to the first track member and the second sliding member and the second arm may be connected to the second track member and the second sliding member. In example embodiments, the first actuator may be configured to rotate the first arm, the second actuator may be configured to rotate the second arm, and the third actuator may be configured to one of extend and retract the telescoping structure. In example embodiments, when the first arm and the second arm rotates an end of the second sliding member may move along the track.

In example embodiments, the spray head positioning device may be a tray mounted device. Thus, the spray head positioning device may be relatively easy to install and remove from in a bin washing system. Furthermore, servicing of the spray head positioning device may also be relatively easy since the device may be removed from a bin washing system and moved to a shop for maintenance.

### BRIEF DESCRIPTION OF THE DRAWINGS

Example embodiments are described in detail below with reference to the attached drawing figures, wherein:

FIGS. 1A-1C are views of a conventional bin cleaning apparatus;

FIG. 2 is a view of a spray head positioning device in accordance with example embodiments;

FIG. 3 is another view of the spray head positioning device in accordance with example embodiments;

FIG. 4 is a side view of the spray head positioning device in accordance with example embodiments, the spray head positioning device being in a folded position;

FIG. 5 is a side view the spray head positioning device in accordance with example embodiments, the spray head positioning device being in an unfolded position;

FIG. 6 is a side view of the spray head positioning device in accordance with example embodiments, the spray head positioning device being in an extended position;

FIG. 7 is a view of the spray head positioning device in accordance with example embodiments, wherein an actuating member is not shown;

FIG. 8 is a view of a guide and a slide member of the spray head positioning device in accordance with example embodiments;

FIG. 9 is a view of a guide and a track of the spray head positioning device in accordance with example embodiments;

FIG. 10 is a view of a slide member and a bracket of the spray head positioning device in accordance with example embodiments;

FIG. 11 is a view of the spray head positioning device mounted on a screen in accordance with example embodiments; and

FIGS. 12-14 illustrate an operation of cleaning an inside of a trash bin in accordance with example embodiments.

### DETAILED DESCRIPTION

Example embodiments will now be described more fully with reference to the accompanying drawings, in which example embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, the sizes of components may be exaggerated for clarity.

It will be understood that when an element or layer is referred to as being “on,” “connected to,” or “coupled to” another element or layer, it can be directly on, connected to, or coupled to the other element or layer or intervening elements or layers that may be present. In contrast, when an element is referred to as being “directly on,” “directly connected to,” or “directly coupled to” another element or layer, there are no intervening elements or layers present. As used herein, the term “and/or” includes any and all combinations of one or more of the associated listed items.

It will be understood that, although the terms first, second, etc. may be used herein to describe various elements, components, regions, layers, and/or sections, these elements, components, regions, layers, and/or sections should not be limited by these terms. These terms are only used to distinguish one element, component, region, layer, and/or section from another elements, component, region, layer, and/or section. Thus, a first element component region, layer or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the structure in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Embodiments described herein will refer to plan views and/or cross-sectional views by way of ideal schematic views. Accordingly, the views may be modified depending on manufacturing technologies and/or tolerances. Therefore, example embodiments are not limited to those shown in the views, but include modifications in configurations formed on the basis of manufacturing process. Therefore, regions exemplified in the figures have schematic properties and shapes of regions shown in the figures exemplify specific shapes or regions of elements, and do not limit example embodiments.

The subject matter of example embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Generally, example embodiments relate to a spray head positioning device usable with a mobile bin washing apparatus.

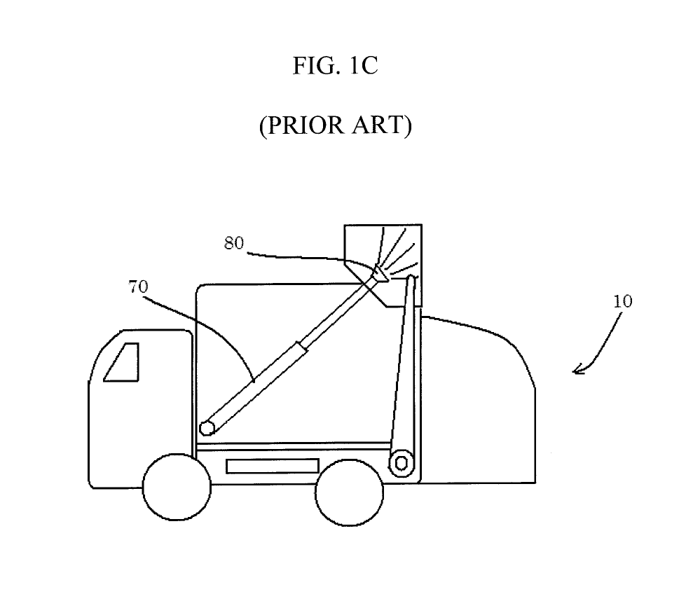

FIG. 2 is a view of a spray head positioning device 1000 in accordance with example embodiments. In example embodiments, the spray head positioning device 1000 includes a wash head mounting structure 150 to which a wash head 100 may be attached. The wash head 100 may be configured to spray a liquid, for example, water, under a relatively high pressure. In example embodiments, the wash head mounting structure 150 may resemble a flat plate to which the wash head 100 may attach. In example embodiments, the wash head 100 may be attached to the wash head mounting structure 150 by a conventional method such as welding, riveting, bolting, clipping, clamping, or pinning. Although the wash head mounting structure 150 is illustrated and described as a plate-like structure, the invention is not limited thereto as the wash head mounting structure 150 could be formed in the shape of a shell or some other structure which is suitable for serving as a mount for the wash head 100.

In example embodiments, the wash head mounting structure 150 may be attached to a sliding structure 200. As shown in FIG. 2, the sliding structure 200 may include a first slide member 210 and a second slide member 220. In example embodiments, the first slide member 210 may be largely restrained by the second slide member 220 so that the first slide member 210 can only translate along the second slide member 220. For example, each of the first and second slide members 210 and 220 may be rectangular tubes with one of the tubes being configured to slide in the other. For example, as shown in FIG. 2, the first slide member 210 may be configured to slide within the second slide member 220. Example embodiments, however, are not limited thereto. For example, the first slide member 210 may be configured to slide on an outside of the second slide member 220. In either case, the sliding structure 200 may be configured as a telescoping structure which may either expand or retract. In example embodiments, the wash head mounting structure 150 may be attached to the first slide member 210 by a conventional method such as welding, riveting, bolting, clipping, clamping, or pinning.

In FIGS. 2-6 the first and second slide members 210 and 220 are illustrated as rectangular tubes. Example embodiments, however, are not limited thereto. For example, the first and second slide members 210 and 220 may be circular tubes or some other structure which allows one member to slide with respect to the other.

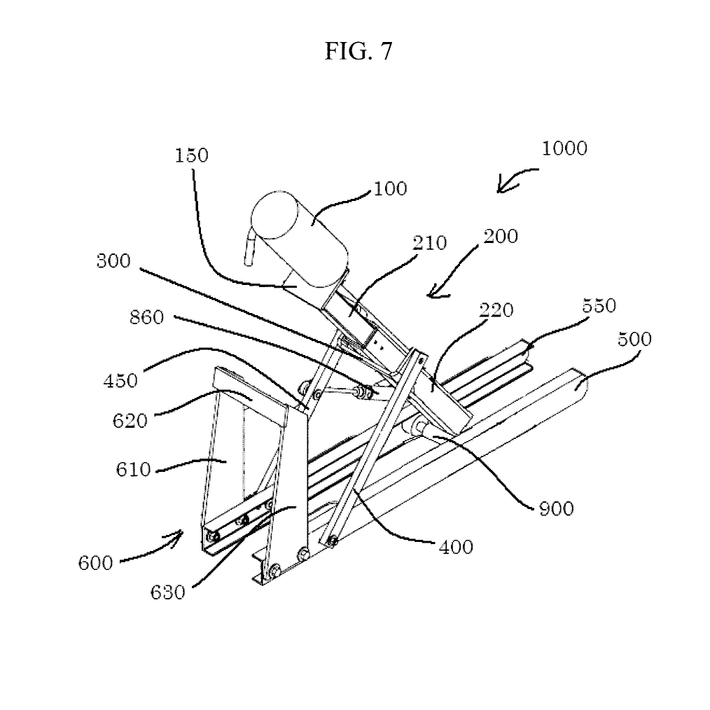

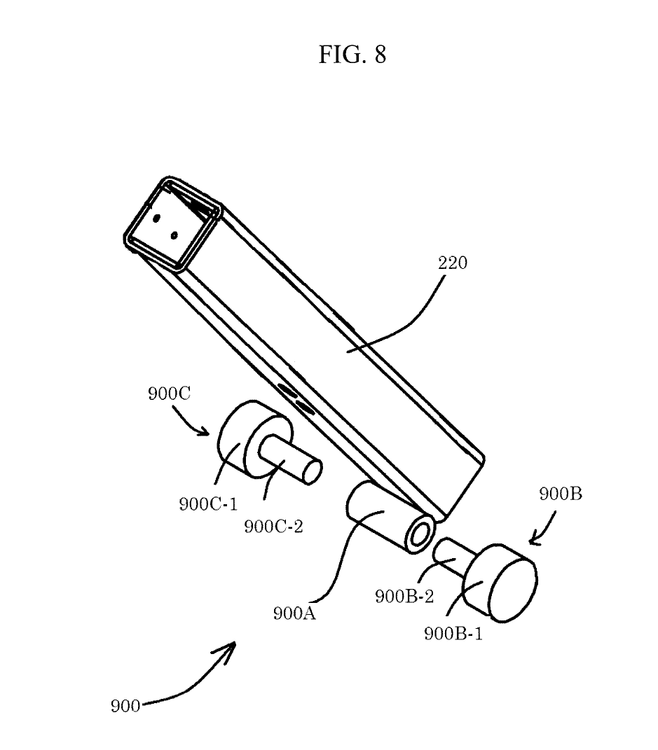

In example embodiments, a first end 200A of the sliding structure 200 may be attached a guide 900 (see FIGS. 7 and 8, noting that FIG. 7 is simply a duplicate of FIG. 2 with an actuating device removed for the sake of clarity). In example embodiments, the guide 900 may be configured to guide the first end 200A of the first sliding structure 200. The guide 900, for example, may be comprised of three elements: a sleeve 900A, a first roller 900B, and a second roller 900C. The sleeve 900A may resemble a cylinder and may be attached to the second slide member 220 by a conventional method such as welding, bolting, clamping, and/or pinning. The first and second rollers 900B and 900C may be configured to engage the sleeve 900A. For example the first roller 900B may include a rolling member 900B-1 (for example, a wheel) and a protruding member 900B-2 that may be configured to protrude into the sleeve 900A. Similarly, the second roller 900C may include a rolling member 900C-1 (for example, a wheel) and a protruding member 900C-2 configured to protrude into the sleeve 900A. In example embodiments, the first and second rollers 900B and 900C may be configured to rotate with respect to the sleeve 900A. Thus, the guide 900 may resemble a rolling assembly. Example embodiments, however, are not limited by the above example. For example, in example embodiments the sleeve 900A may be a substantially solid cylinder and the first and second rollers 900A and 900B may simply constitute wheels with holes configured to engage the substantially solid cylinder.

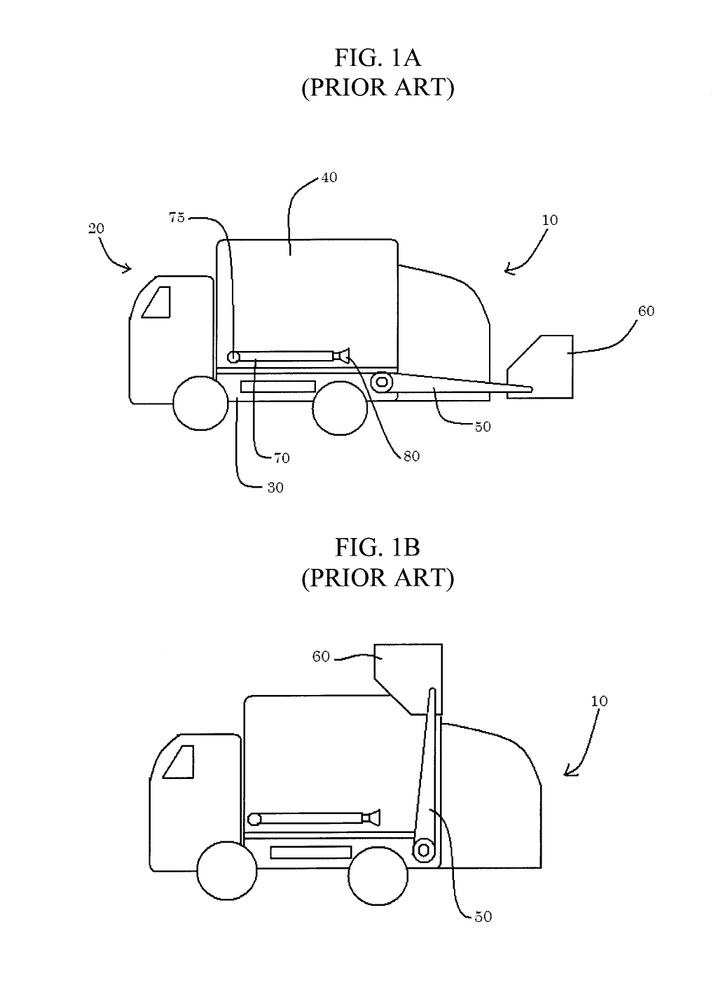

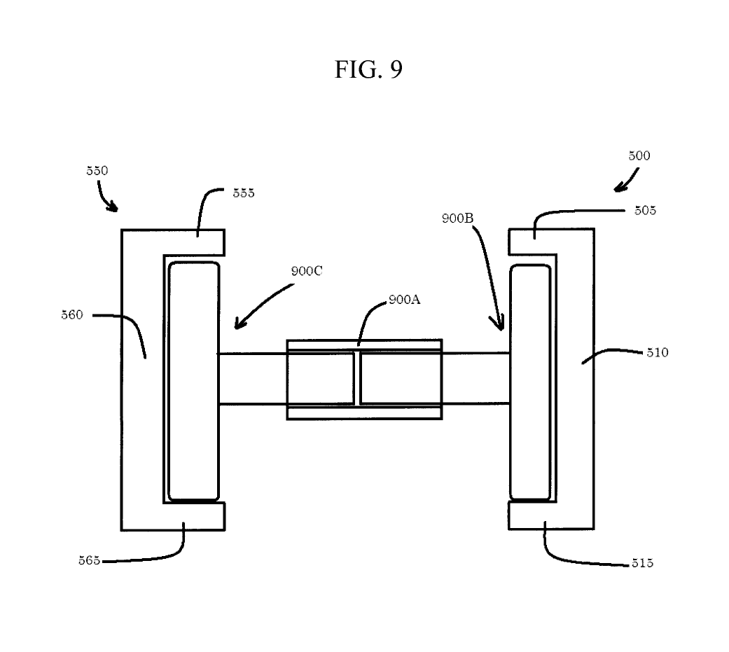

In example embodiments, the guide 900 may be configured to interact with a track. The track, for example may be comprised of a first track member 500 and a second track member 550. As shown in at least FIGS. 1, 2, and 9 each of the first and second track members 500 and 550 may have a C-shaped cross section. FIG. 9 is a view of the guide 900 interacting with the track in accordance with example embodiments. As shown in FIG. 9, the first track member 500 may include a first horizontal member 515 upon which the first roller 900B may be supported. In example embodiments, the first track member 500 may also include a first vertical member 510 and a second horizontal member 505. The first vertical member 510 may prevent the first roller from 900B from moving laterally and the second horizontal member 505 may prevent the first roller 900B from moving vertically. Similarly, the second track member 550 may include a third horizontal member 565 upon which the second roller 900C may be supported. In example embodiments, the second track member 550 may also include a second vertical member 560 and a fourth horizontal member 555. The second vertical member 560 may prevent the second roller from 900C from moving laterally and the fourth horizontal member 555 may prevent the second roller 900C from moving vertically. In example embodiments, however, while the guide 900 is restrained from moving vertically and laterally, the guide 900 is free to translate (for example, roll along) the track. In example embodiments, each of the first and second track members 500 and 550 may be made from channel iron, however, example embodiments are not limited thereto as other materials (for example, steel and/or plastic) may be used in lieu of iron. Furthermore, other shapes such as an I-shape or an H-shape may be suitably used for the first and second track members 500 and 550.

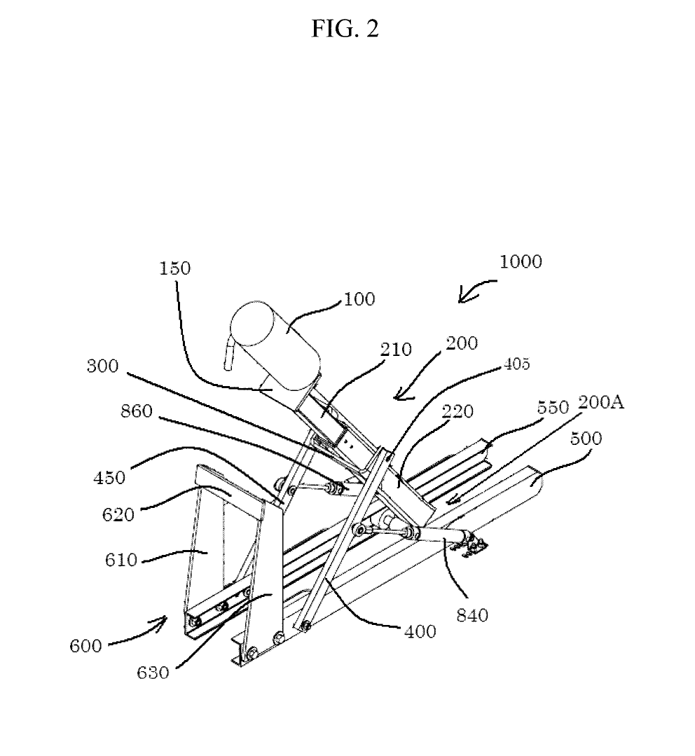

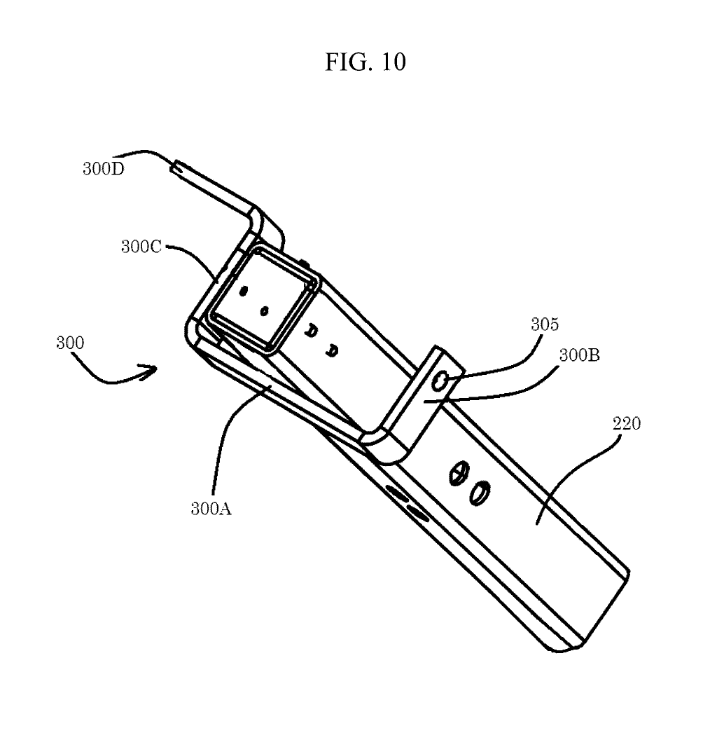

In example embodiments, the sliding structure 200 may be supported by a bracket and arm assembly. For example, as illustrated in FIGS. 2 and 3, and more particularly in FIG. 10, the bracket 300 may have a mounting portion 300A which may be used to attach the bracket 300 to the second slide member 220 of the sliding structure 200. The mounting portion 300A, for example, allows for the bracket 300 to be welded, bolted, pinned, clamped, or riveted to the second slide member 220. In example embodiments, the bracket 300 may also include a first connecting flange 300B to connect the bracket 300 to a first arm 400 and a second connecting flange 300C to connect the bracket 300 to a second arm 450. In example embodiments, the connection between the bracket 300 and the first and second arms 400 and 450 may be facilitated by a pin-type connection. For example, each of the first connecting flange 300B and the first arm 400 may include a hole (see 305 and 405 FIGS. 1 and 10) which may be aligned. The aligned holes may then have a pin (or pin type member such as a pin, a screw, or a bolt) inserted therein to create the pin type connection. The second arm 450 and the second connecting flange 300C may be similarly connected.

As shown in FIG. 10, the bracket 300 may include a third flange member 300D. The third flange member 300D may be used to support a hose protection structure 700 (to be explained later). In example embodiments, the bracket 300 may be constructed from a single rectangular plate which is bent at three locations to form the first, second, and third connecting flanges 300B, 300C, and D, and the mounting portion 300A. In the alternative, the bracket 300 may be a built up member fabricated by welding together different plates. Further yet, the bracket 300 may be formed as a single member from a casting process. In example embodiments, the configuration of the bracket 300 is illustrative only and is not meant to limit the invention.

In example embodiments, the first and second arms 400 and 450 may resemble rectangular shaped rods having first ends connected to the bracket 300 as shown in at least FIGS. 2 and 3 and second ends connected to the track. For example, as shown in FIGS. 2 and 3, the first and second arms 400 and 450 may have second ends that are pin-connected to the track by a pin type connection. For example, each of the first track member 500 and the first arm 400 may include a hole through which a pin (or pin type member such as a pin, a bolt, or a screw) may be inserted. This type of connection allows the first arm to rotate relative to the first track member 500. Similarly, the second track member 550 and the second arm 450 may each include a hole through which a pin (or pin type member such as a screw) may be inserted. This type of connection allows the second arm 450 to rotate relative to the second track member 550.

As indicated above, the first and second arms 400 and 450 may resemble rectangular shaped rods. This aspect of example embodiments is not intended to be a limiting feature of the invention since the first and second arms may have a different shape. For example, each of the first and second arms 400 and 450 could have a polygon shaped cross-section, a circular shaped cross-section, or an elliptical shaped cross-section. Furthermore, the first and second rods 400 and 405 may be formed as curved members or irregular shaped members rather than straight members as is shown in the figures. In addition, the first and second arms 400 and 450 do not have to be shaped like a rod. For example, the first and second arms 400 and 450 may resemble a semicircle or a plate.

In example embodiments, various actuating members are provided to move the spray head positioning device 1000 into different configurations. For example, the spray head positioning device 1000 may include a first actuating device 840 configured to attach to and move the first arm 400. For example, the first actuating device 840 may be a pneumatic cylinder. As shown in FIG. 2, the first actuating device 840 may have a first rod attached to a middle portion of the first arm 400. The connection between the first rod and the first arm 400 may be a pin type connection. For example, each of the first rod and the first arm 400 may include a hole through which a pin (or pin type member such as a pin, a bolt, or a screw) may be inserted. In example embodiments, the spray head positioning device 1000 may also include a second actuating device 860 configured to attach to and move the second arm 450. For example, the second actuating device 860 may be a pneumatic cylinder. As shown in FIG. 2, the second actuating device 860 may have a second rod attached to a middle portion of the second arm 450. The connection between the second rod and the second arm 450 may be a pin type connection. For example, each of the second rod and the second arm 450 may include a hole through which a pin (or pin type member such as a pin, a bolt, or a screw) may be inserted.

In example embodiments the spray head positioning device 1000 may further include a third actuating device 800 (see FIG. 3) configured to control the sliding structure 200. For example, the third actuating device 800 may be configured to cause the first slide member 210 to move relative to the second slide member 220. In example embodiments, the third actuating device 800 may be a pneumatic cylinder. In the event the third actuating device 800 is a pneumatic cylinder, a cylinder of the pneumatic cylinder may be connected to the second slide member 210 and a rod of the pneumatic cylinder may be connected to one of (or both of) the first slide member 210 and the wash head mounting structure 150. In example embodiments, the third actuating device 800 may be attached to the spray head positioning device 1000 by a conventional method such as bolting or welding. For example, in the event the third actuating device 800 is a pneumatic cylinder, the rod of the pneumatic cylinder may be welded directly to one of (or both of) the first slide member 210 and the wash head mounting structure 150 or may be attached thereto via a bracket which may in turn be welded or bolted to one of (or both of) the first slide member 210 and the wash head mounting structure 150. Similarly, the cylinder of the pneumatic cylinder may be welded directly to the second slide member 220 or may be attached thereto via a bracket which may in turn be welded or bolted to the second slide member 220.

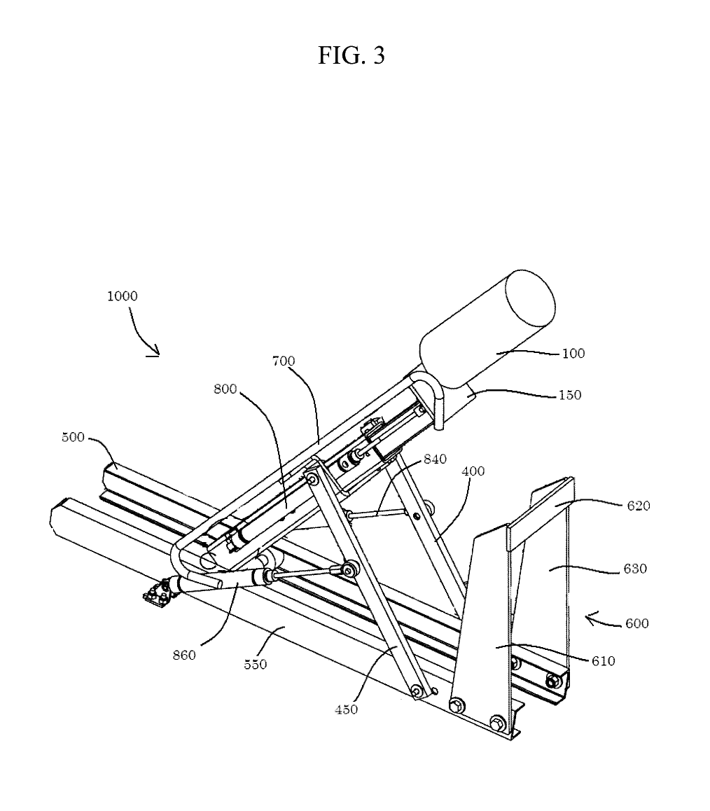

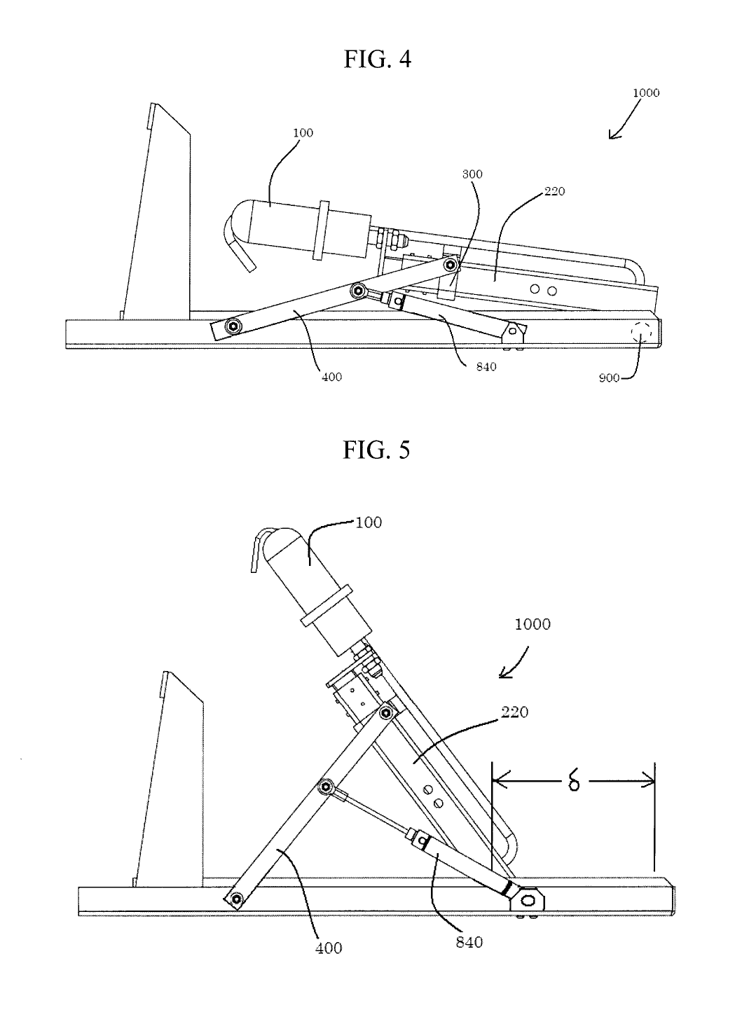

Referring to FIG. 3, a hose protection structure 700 may be provided to protect a hose (not pictured) from being from being impacted by a trash bin lid. In example embodiments the hose protection structure 700 is illustrated as being attached to the third attachment flange 300D. The attachment may be facilitated by a common method such as bolting, welding, riveting, or pinning. As shown in FIGS. 4 and 5 a length of the hose protection structure 700 may be about equal to a length of the sliding structure 200 (in the collapsed configuration) plus a length of the wash head 100 thus offering protection of the wash head and the hose connected to the wash head 100.

In example embodiments, a bin wash stop 600 may be provided. The bin wash stop 600, as shown in FIG. 2, may be a substantially inverted “U” shaped structure. For example, as shown in FIG. 2, the bin wash stop 600 may be comprised of a pair of vertical plates 610 and 630 connected by a substantially horizontal plate 620. In example embodiments, the bin wash stop 600 may be connected to the track of the spray head positioning device 1000 by a conventional method such as bolting (as illustrated in the figures). Example embodiments, however, are not limited thereto as another means such as pinning or welding may be employed.

Although the bin wash stop 600 is illustrated as an inverted “U” shaped structure, example embodiments are not limited thereto. For example, the bin wash stop 600 may be a T-shaped or L-shaped structure or any other suitable structure configured to prevent a trash bin from getting too close to the wash head 100.

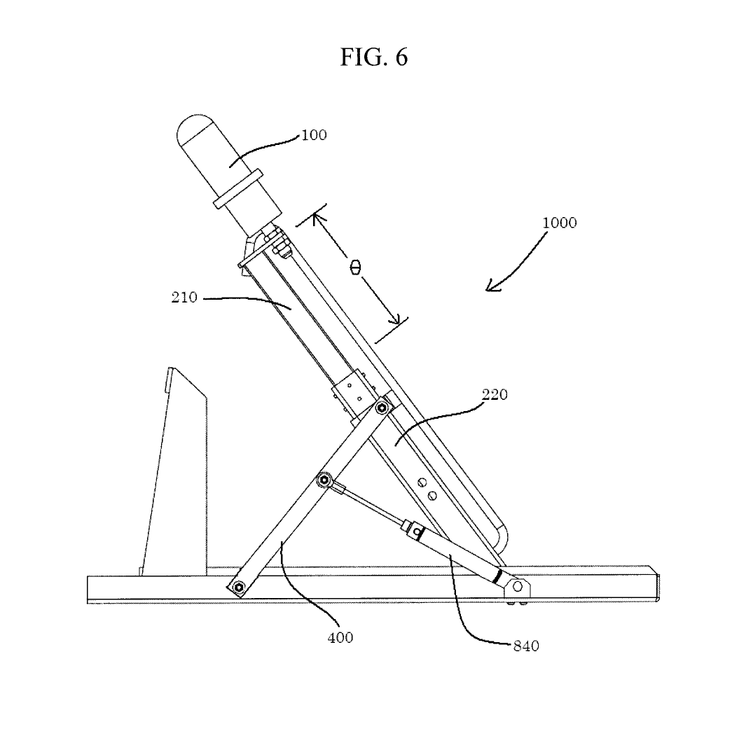

FIGS. 4-6 represent different configurations of the spray head positioning device 1000. In FIG. 4, for example, the spray head positioning device 1000 is shown in a folded configuration. In FIG. 5, for example, the spray head positioning device 1000 is shown in an unfolded position. In FIG. 6, for example, the spray head is illustrated as being in an extended configuration.

In example embodiments, the spray head positioning device 1000 may transform from the folded configuration to the unfolded configuration and from the unfolded position to the extended position by operating the first, second, and third actuating devices 840, 860, and 800. For example, if the first and second actuating devices 840 and 860 are pneumatic cylinders air may be fed to the first and second actuating devices 840 and 860 to drive their corresponding rods outwards causing the first and second arms 400 and 450 to rotate and a back end of the sliding structure 200 to move a distance δ along the track. These actions position the spray head positioning device 1000 in the unfolded configuration. Thereafter, the third actuating device 800 may be actuated to cause the first slide member 210 to move through the second slide member 220 thus extending a length of the sliding structure 200 to place the spray head positioning device 1000 in the extended position.

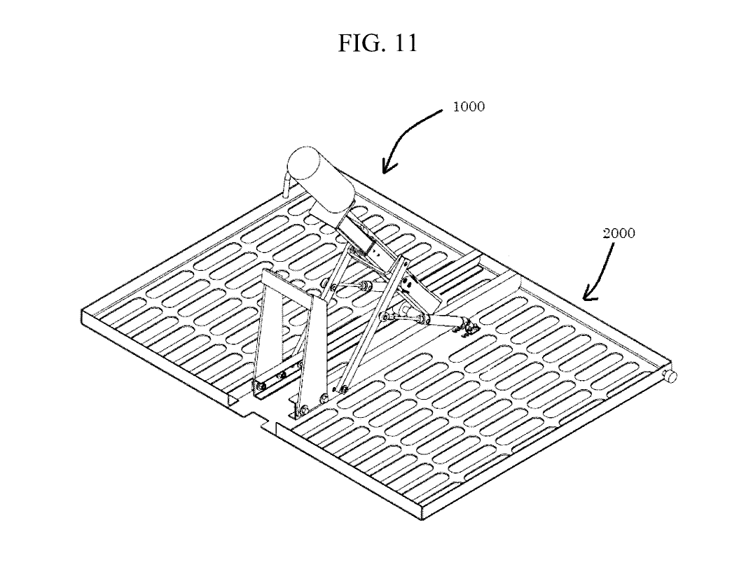

As alluded to earlier, the spray head positioning device 1000 is usable with a bin washing apparatus. FIG. 11 is a view of the spray head positioning device 1000 mounted on a screen 2000. As shown in FIG. 11, the screen may contain a plurality of openings through which waste water from a bin cleaning operation may drain. In example embodiments, the bin washing apparatus may or may not be mobile. In example embodiments, the screen 2000 may be a part of the bin washing apparatus or may be considered another element of the spray head positioning device 1000.

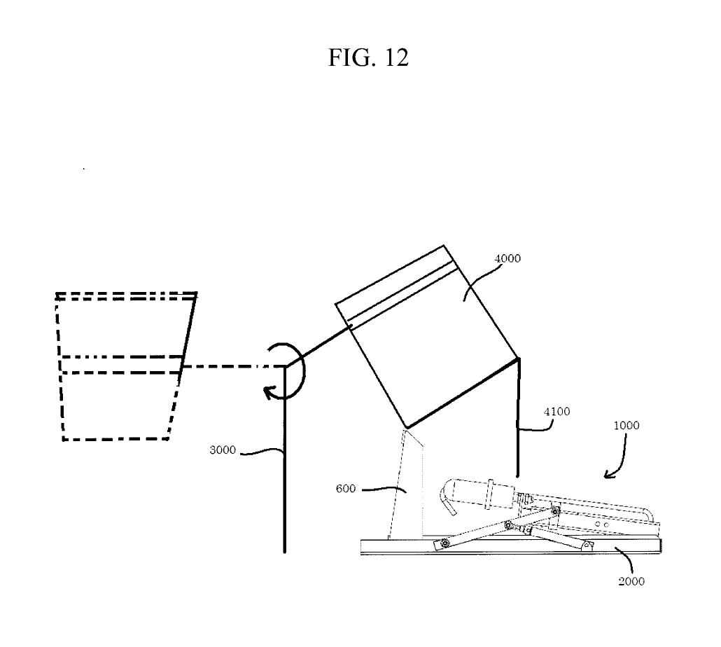

FIGS. 12-14 illustrate a bin cleaning operation in accordance with example embodiments. In FIGS. 12-14, the spray head positioning device 1000 is arranged on a screen 2000 in a mobile bin washing system. In example embodiments, the mobile bin washing system includes an arm 3000 which is configured to grab, lift, and rotate a trash bin 4000. FIG. 12, for example, shows the arm 3000 holding the trash bin 4000. In example embodiments, the trash bin 4000 may contact the bin wash stop 600 which may prevent the trash bin 4000 from becoming too close to the spray head positioning device 1000. As shown in FIG. 12, a lid 4100 of the trash bin 4000 may hang vertically under the force of gravity. In FIG. 12, the spray head positioning device 1000 is in the folded position.

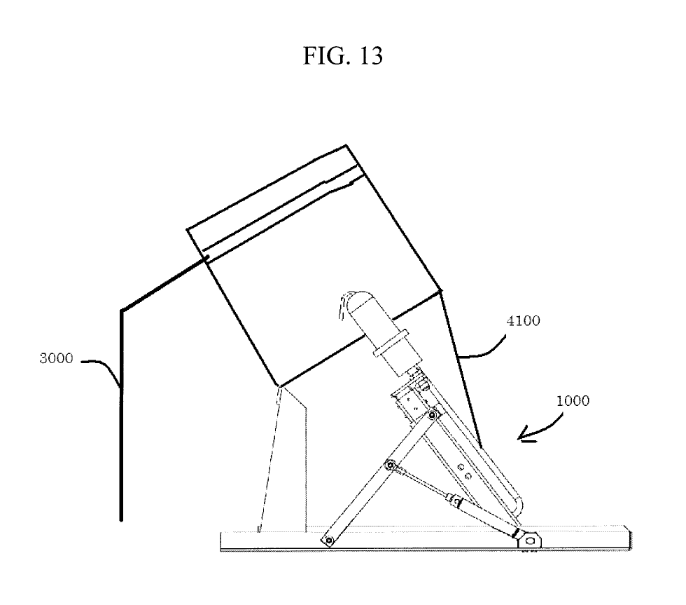

FIG. 13 illustrates an operation wherein the spray head positioning device 1000 moves from the folded position to the unfolded position. Because the spray head positioning device 1000 according to example embodiments includes a hose protection structure 700, the trash bin lid 4100 may be prevented from contacting a wash hose which may be arranged on a top side of the sliding structure 200. Though not illustrated in the figures, the wash hose may provide wash fluid, for example, water, to the wash head 100 under a relatively high pressure.

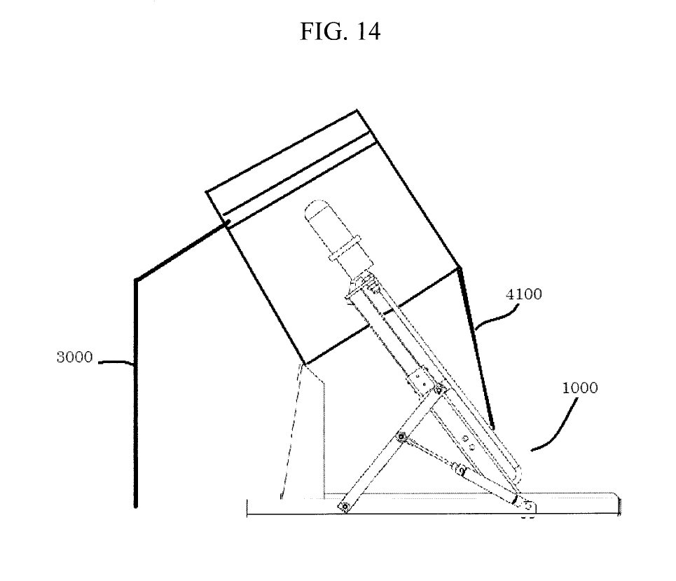

FIG. 14 illustrates an operation wherein the spray head positioning device 1000 moves from the unfolded position to the extended position. In this position, the wash head 100 is moved to an inside of the trash bin 4000. In this location, high pressure fluid liquid from the wash hose may be sprayed onto inside surfaces of the trash bin 4000 via the wash head 100 allowing the inside of the trash bin 4000 to be cleaned. In example embodiments, the above operations may be reversed to remove the trash bin 4000 from the mobile bin washing apparatus.

While example embodiments have been particularly shown and described with reference to example embodiments thereof, it will be understood by those of ordinary skill in the art that various changes in form and details may be made therein without departing from the spirit and scope of the invention.

What we claim is:

1. A spray head positioning device comprising:
a wash head mounting structure;
a sliding structure supporting the wash head mounting structure;
a track configured to engage the sliding structure, wherein sliding structure includes an end configured to traverse along the track.

2. The spray head positioning device according to claim 1, wherein
the track comprises a first track member and a second track member, and
the end of the sliding structure includes a guide configured to move between the first track member and the second track member.

3. The spray head positioning device according to claim 2, wherein each of the first and second track members include horizontal members configured to vertically restrain the guide, a vertical member configured to laterally restrain the guide.

4. The spray head positioning device according to claim 2, wherein the guide comprises a first roller and second roller.

5. The spray head positioning device, further comprising:
a first arm configured to move the a sliding structure along the track.

6. The spray head positioning device according to claim 5, wherein the first arm is further configured to change an angle of incline of the sliding structure.

7. The spray head positioning device according to claim 5, further comprising:
a first actuator configured to rotate the first arm.

8. The spray head positioning device according to claim 1, wherein the sliding structure includes a first slide member slidingly engaged with a second slide member.

9. The spray head positioning device according to claim 8, further comprising:
an actuator configured to move the first slide member with respect to the second slide member.

10. The spray head positioning device according to claim 1, further comprising:
a screen connected to the track.

11. The spray head positioning device according to claim 1, further comprising:
a bin wash stop connected to the track.

12. The spray head positioning device according to claim 1, further comprising:
a hose protection structure on a side of the sliding structure.

13. A spray head positioning device, comprising:
a wash head mounting structure;
a telescoping structure attached to the wash head mounting structure, the telescoping structure including a first sliding member telescopingly engaged with a second sliding member;
a guide attached to an end of the second sliding member, the guide comprising a sleeve, a first rolling member, and a second rolling member;
a track comprised of a first track member and a second track member, the first track member supporting and restraining the first rolling member and the second track member supporting and restraining the second rolling member;
a first arm connected to the first track member and the second sliding member;
a second arm connected to the second track member and the second sliding member;
a first actuator configured to rotate the first arm;
a second actuator configured to rotate the second arm; and
a third actuator configured to one of extend and retract the telescoping structure, wherein as the first arm and the second arm rotated an end of the second sliding member moves along the track.
